(19) United States
(12) Patent Application Publication
(10) Pub. No.: US 2026/0063602 A1
(43) Pub. Date: Mar. 5, 2026

(54) CHROMATOGRAM ANALYSIS APPARATUS

(71) Applicant: SHIMADZU CORPORATION, Kyoto (JP)

(72) Inventor: Tomohiro KAWASE, Kyoto (JP)

(73) Assignee: SHIMADZU CORPORATION, Kyoto (JP)

(21) Appl. No.: 19/289,229

(22) Filed: Aug. 4, 2025

(30) Foreign Application Priority Data
Aug. 28, 2024 (JP) 2024-146350

(51) Int. Cl. G01N 30/86; G01N 30/02

(52) U.S. Cl. CPC G01N 30/8631; G01N 2030/027

(57) ABSTRACT

A chromatogram analysis apparatus comprises a system information storage unit configured to store a system volume, which is a volume of piping through which a sample of a fluid chromatograph passes; an analysis information storage unit configured to store a chromatogram acquired by an analysis performed by the fluid chromatograph, flow rate information regarding a flow rate of a mobile phase during the analysis, and composition information regarding a composition of the mobile phase in each time period during the analysis; a time calculation unit configured to calculate a mobile phase arrival time, which is a time required for a mobile phase delivered from a liquid sending unit of the fluid chromatograph to reach a detector, and a sample arrival time, which is a time required for a sample injected into the mobile phase to reach the detector, based on the system information, the flow rate information, and the composition information; an analysis range determination unit configured to determine a target range for peak analysis on the chromatogram based on the mobile phase arrival time and the sample arrival time, such that a composition-derived peak, which is a peak caused by a rapid change in the composition of the mobile phase, and an injection-derived peak, which is a peak caused by the injection of the sample into the mobile phase, are excluded from the analysis target; and a peak analysis unit configured to execute the peak analysis within the analysis range determined by the analysis range determination unit.

### TECHNICAL FIELD

The present invention relates to a chromatogram analysis apparatus.

### BACKGROUND ART

There are apparatuses that perform analysis processing of chromatograms acquired by fluid chromatographs such as liquid chromatographs and supercritical fluid chromatographs (see Patent Literature 1). A chromatogram analysis apparatus can not only detect peaks appearing in a chromatogram and determine the area of each peak, but also separate a plurality of mutually overlapping peaks to estimate the shape and size of individual peaks.

### CITATION LIST

### Patent Literature

[Patent Literature 1] Japanese Unexamined Patent Application Publication No. 2021-148776

### SUMMARY OF INVENTION

### Technical Problem

In liquid chromatographs and supercritical fluid chromatographs, a rapid change in the composition of the mobile phase or a rapid change in pressure due to sample injection may be recorded as a peak on the chromatogram. However, if such a noise peak is recognized by the analysis apparatus as a peak derived from a component in the sample, the reliability of the analysis result is compromised. For example, when the number of components contained in a sample is known, the number of peaks to be analyzed may be set in advance. However, if a noise peak is recognized as a component peak, a component peak that should originally be analyzed is omitted from the analysis target, leading to a situation where the analysis is not executed. Therefore, it is necessary for the user to remove noise peaks that are not derived from components before executing the analysis processing, but such work is complicated, and it has been difficult to distinguish whether a peak is a component-derived peak or a noise peak.

The present invention has been made in view of the above problems, and an object thereof is to provide a chromatogram analysis apparatus having a function of automatically excluding noise peaks from the analysis target.

### Solution to Problem

A chromatogram analysis apparatus according to the present invention comprises:
a system information storage unit configured to store a system volume, which is a volume of piping through which a sample of a fluid chromatograph passes;
an analysis information storage unit configured to store a chromatogram acquired by an analysis performed by the fluid chromatograph, flow rate information regarding a flow rate of the mobile phase during the analysis, and composition information regarding a composition of the mobile phase in each time period during the analysis;
a time calculation unit configured to calculate a mobile phase arrival time, which is a time required for a mobile phase delivered from a liquid sending unit of the fluid chromatograph to reach a detector, and a sample arrival time, which is a time required for a sample injected into the mobile phase to reach the detector, based on the system volume, the flow rate information, and the composition information;
an analysis range determination unit configured to determine a target range for peak analysis on the chromatogram based on the mobile phase arrival time and the sample arrival time, such that a composition-derived peak, which is a peak caused by a rapid change in the composition of the mobile phase, and an injection-derived peak, which is a peak caused by the injection of the sample into the mobile phase, are excluded from the analysis target; and
a peak analysis unit configured to execute the peak analysis within the analysis range determined by the analysis range determination unit.

### Advantageous Effects of Invention

According to the chromatogram analysis apparatus of the present invention, the mobile phase arrival time and the sample arrival time are determined based on the system volume of the fluid chromatograph, the flow rate information of the mobile phase, and the composition information regarding the composition of the mobile phase in each time period. The analysis range is determined based on the calculated mobile phase arrival time and sample arrival time so that the noise peaks, which are the composition-derived peak and the injection-derived peak, are excluded from the analysis target, and the peak analysis is executed within the determined analysis range. Therefore, noise peaks can be automatically excluded from the analysis target.

### BRIEF DESCRIPTION OF DRAWINGS

FIG. 1 is a schematic configuration diagram showing an embodiment of a chromatogram analysis apparatus.

FIG. 2 is a diagram showing an example of the procedure for determining the analysis range in the embodiment, wherein the upper diagram is a chromatogram obtained by analyzing a certain sample, and the lower diagram is a graph showing the composition of the mobile phase (B liquid concentration) in each time period during the analysis.

FIG. 3 is a flowchart for explaining an example of the operation of the embodiment.

### DESCRIPTION OF EMBODIMENTS

Hereinafter, an embodiment of a chromatogram analysis apparatus will be described with reference to the drawings.

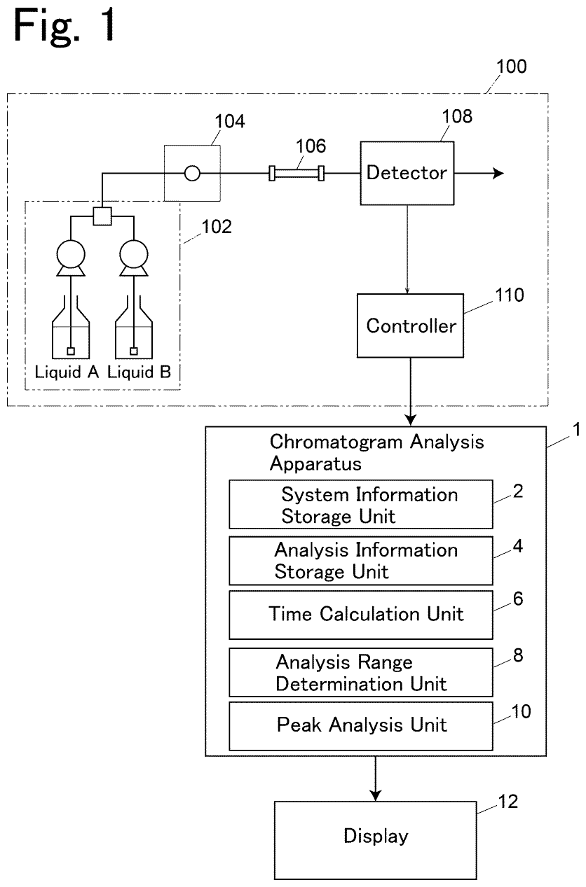

As shown in FIG. 1, a chromatogram analysis apparatus 1 is an apparatus that performs analysis of a chromatogram acquired by performing an analysis of a sample with a fluid chromatograph 100, and is realized by a computer device (for example, a personal computer) in which an analysis program is installed.

The fluid chromatograph 100 is a liquid chromatograph and includes a liquid sending unit 102, an autosampler 104, a separation column 106, a detector 108, and a controller 110. The liquid sending unit 102 sends two types of liquids, A liquid and B liquid, to a mixer to be mixed, and delivers the mixed liquid as a mobile phase. The autosampler 104 is fluidly connected downstream of the liquid sending unit 102 and injects a sample into the mobile phase delivered from the liquid sending unit 102. The separation column 106 is fluidly connected downstream of the autosampler 104 and separates a plurality of components in the sample injected into the mobile phase by the autosampler 104 from each other. The detector 108 is fluidly connected downstream of the separation column 106 and outputs a signal with an intensity corresponding to the concentration of each component separated from each other in the separation column 106. The controller 110 controls the operation of at least the liquid sending unit 102 and the autosampler 104. The signal output from the detector 108 is input to the chromatogram analysis apparatus 1 through the controller 110.

Note that, although the fluid chromatograph 100 for acquiring a chromatogram of a sample is a liquid chromatograph here, it may be a supercritical fluid chromatograph or an ion chromatograph.

The chromatogram analysis apparatus 1 includes a system information storage unit 2, an analysis information storage unit 4, a time calculation unit 6, an analysis range determination unit 8, and a peak analysis unit 10. The system information storage unit 2 and the analysis information storage unit 4 are functions realized by a part of a storage area of an information storage device such as a hard disk drive or a flash memory. The time calculation unit 6, the analysis range determination unit 8, and the peak analysis unit 10 are functions realized by a CPU (Central Processing Unit) executing a predetermined program.

The system information storage unit 2 stores system information including the system volume of the fluid chromatograph 100. The system volume can include the volume from the mixer of the liquid sending unit 102 to the autosampler 104, the volume of the flow path in the autosampler 104, the volume from the autosampler 104 to the separation column 106, the volume in the separation column 106, and the volume from the separation column 106 to the detector 108.

The analysis information storage unit 4 stores a chromatogram obtained by an analysis performed by the fluid chromatograph 100, flow rate information of the mobile phase during the analysis, and composition information of the mobile phase at each time during the analysis (for example, a gradient program).

The time calculation unit 6 is configured to calculate a sample arrival time T1, which is the time required for a sample to reach the detector 108 without being retained by the separation column 106, and a mobile phase arrival time T2, which is the time required for the mobile phase delivered from the liquid sending unit 102 to reach the detector 108, using the system information stored in the system information storage unit 2 and the flow rate information and composition information stored in the analysis information storage unit.

The sample arrival time T1 can be obtained by dividing the internal volume from the autosampler 104 to the detector 108 by the flow rate of the mobile phase. The mobile phase arrival time T2 can be obtained by dividing the internal volume from the liquid sending unit 102 to the detector 108 by the flow rate of the mobile phase.

The analysis range determination unit 8 is configured to determine an analysis range on the chromatogram based on the sample arrival time T1 and the mobile phase arrival time T2 calculated by the time calculation unit 6. The analysis range is determined so as not to include an injection-derived peak, which is a peak that may appear due to the injection of the sample, and a composition-derived peak, which is a peak that may appear due to a rapid change in the composition of the mobile phase.

The peak analysis unit 10 is configured to execute peak analysis of the chromatogram within the analysis range determined by the analysis range determination unit 8.

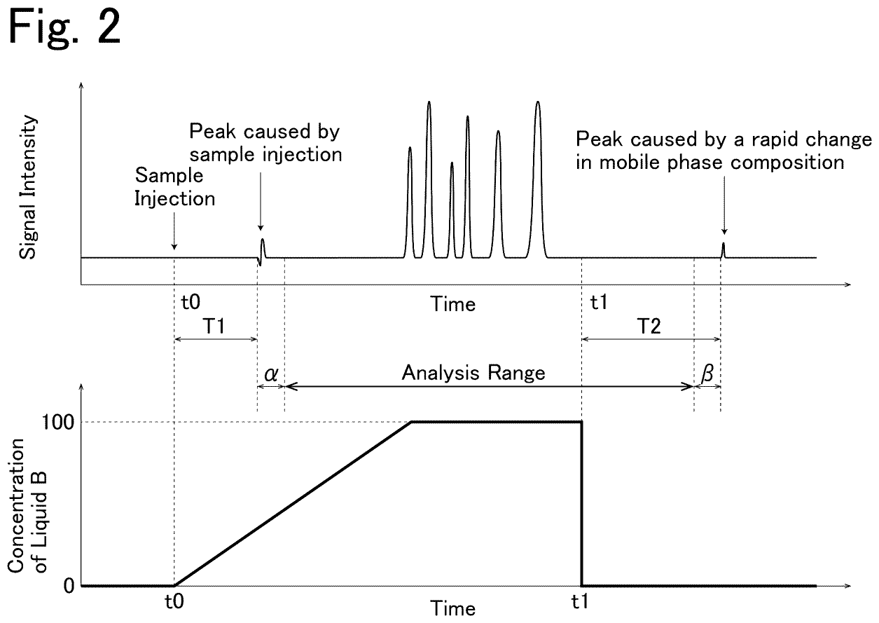

The procedure for determining the analysis range will be described with reference to FIG. 2.

The injection-derived peak, which is caused by the injection of the sample, may appear at a position corresponding to the time when the solvent injected with the sample reaches the detector, that is, at a position near the time t0+T1, where t0 is the time when the sample was injected. However, as shown in FIG. 2, the injection-derived peak may have a negative intensity portion in the first half of the peak. Therefore, when a peak appears near the time t0+T1, it can be determined whether it is an injection-derived peak based on whether the peak has a negative intensity portion. When a peak having a negative intensity portion appears near the time t0+T1 on the chromatogram, the start time of the analysis range can be set to t0+T1+α so as to exclude this peak from the analysis target. α is a value set with a sufficient margin so that the injection-derived peak is not included in the analysis target.

On the other hand, if a peak appears near the time t0+T1 on the chromatogram but does not have a negative intensity portion, this peak is considered to be a peak derived from a component for which the separation column 106 has no retention (elutes from the separation column 106 together with the solvent). Therefore, the analysis range is set to include this peak. In this case, for example, the start point of the analysis range can be set to t0+T1−α.

Furthermore, a composition-derived peak, which is caused by a rapid change in the composition of the mobile phase, may appear at a position near the time t1+T2, where t1 is the time when the composition of the mobile phase delivered by the liquid sending unit 102 was rapidly changed, and T2 is the mobile phase arrival time required for the mobile phase with the rapidly changed composition to reach the detector 108 from the liquid sending unit 102. Therefore, the end time of the analysis range can be set to t1+T2−β so as to exclude the composition-derived peak from the analysis target. β is a value set with a sufficient margin so that the composition-derived peak is not included in the analysis target. β may be the same as or different from α.

Note that the timing at which the composition of the mobile phase changes rapidly includes, as in the example of FIG. 2, the timing of returning the B liquid concentration to the equilibration concentration (0%) after a certain period of time has elapsed since the B liquid concentration in the mobile phase was gradually increased after sample injection and analysis started, and the B liquid concentration reached 100% (after the gradient elution ended). Another example is the timing of increasing the B liquid concentration to a washing concentration (100%) after the B liquid concentration in the mobile phase was gradually increased and reached the final concentration (e.g., 80%) to which the concentration was increased in the gradient. The timing at which the composition of the mobile phase changes rapidly can be known, for example, from a gradient program set for each analysis.

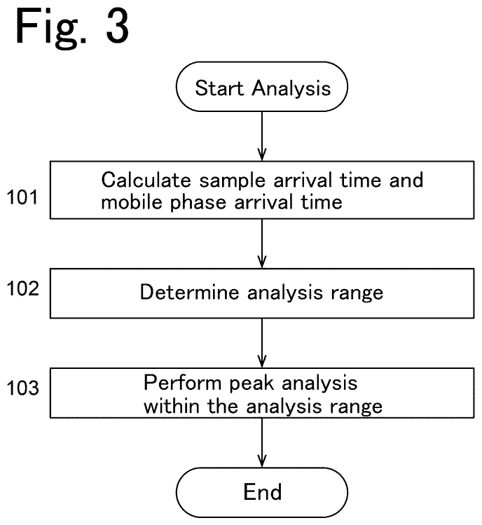

Next, the procedure for peak analysis of a chromatogram by the chromatogram analysis apparatus 1 will be described with reference to the flowchart of FIG. 3 together with FIG. 1.

When the user selects a chromatogram for which peak analysis is to be performed and inputs an instruction to start the analysis, the time calculation unit 6 calculates the sample arrival time and the mobile phase arrival time based on the information stored in the system information storage unit 2 and the analysis information storage unit 4, respectively (Step 101).

Next, the analysis range determination unit 8 uses the sample arrival time and the mobile phase arrival time calculated by the time calculation unit 6 to determine the analysis range so that the injection-derived peak and the composition-derived peak are excluded from the analysis target (Step 102).

When the analysis range is determined, the peak analysis unit 10 executes the peak analysis within the determined analysis range (Step 103). The chromatogram analysis apparatus 1 outputs the analysis data obtained by the peak analysis by the peak analysis unit 10 to the display 12 to be displayed.

Note that the above embodiment is merely an example of an embodiment of the chromatogram analysis apparatus according to the present invention. Embodiments of the chromatogram analysis apparatus according to the present invention are as follows.

An embodiment of the chromatogram analysis apparatus according to the present invention comprises:
a system information storage unit configured to store a system volume, which is a volume of piping through which a sample of a fluid chromatograph passes;
an analysis information storage unit configured to store a chromatogram acquired by an analysis performed by the fluid chromatograph, flow rate information regarding a flow rate of the mobile phase during the analysis, and composition information regarding a composition of the mobile phase in each time period during the analysis;
a time calculation unit configured to calculate a mobile phase arrival time, which is a time required for a mobile phase delivered from a liquid sending unit of the fluid chromatograph to reach a detector, and a sample arrival time, which is a time required for a sample injected into the mobile phase to reach the detector, based on the system volume, the flow rate information, and the composition information;
an analysis range determination unit configured to determine a target range for peak analysis on the chromatogram based on the mobile phase arrival time and the sample arrival time, such that a composition-derived peak, which is a peak caused by a rapid change in the composition of the mobile phase, and an injection-derived peak, which is a peak caused by the injection of the sample into the mobile phase, are excluded from the analysis target; and
a peak analysis unit configured to execute the peak analysis within the analysis range determined by the analysis range determination unit.

In a first aspect of the above embodiment, the analysis range determination unit is configured to set, when a peak having a negative intensity portion appears in the chromatogram at a position near a time when the sample arrival time has elapsed from a time when the sample was injected into the mobile phase, a time that is a predetermined time after the time when the sample arrival time has elapsed from the time when the sample was injected into the mobile phase as a start time of the analysis range.

In the first aspect, the analysis range determination unit can be configured to set, when a peak having no negative intensity portion appears in the chromatogram at a position near a time when the sample arrival time has elapsed from a time when the sample was injected into the mobile phase, a time that is a predetermined time before the time when the sample arrival time has elapsed from the time when the sample was injected into the mobile phase as a start time of the analysis range.

In a second aspect of the above embodiment, the analysis range determination unit is configured to set a time that is a predetermined time before a time when the mobile phase arrival time has elapsed from a time when the composition of the mobile phase was rapidly changed, at a time after the gradient elution of the mobile phase in the chromatogram has ended, as an end time of the analysis range. This second aspect can be combined with the first aspect.

In a third aspect of the above embodiment, the composition information is a preset gradient program for the mobile phase. This third aspect can be combined with the first aspect and/or the second aspect.

In a fourth aspect of the above embodiment, the system volume includes a first system volume, which is a volume from an autosampler for injecting a sample to a detector, and a second system volume, which is a volume from a liquid sending unit for sending a mobile phase to the detector. This fourth aspect can be combined with the first aspect, the second aspect, and/or the third aspect.

### REFERENCE SIGNS LIST

1 Chromatogram analysis apparatus
2 System information storage unit
4 Analysis information storage unit
6 Time calculation unit
8 Analysis range determination unit
10 Peak analysis unit
12 Display
100 Fluid chromatograph
102 Liquid sending unit
104 Autosampler
106 Separation column
108 Detector
110 Controller

1. A chromatogram analysis apparatus, comprising:
a system information storage unit configured to store a system volume, which is a volume of piping through which a sample of a fluid chromatograph passes; an analysis information storage unit configured to store a chromatogram acquired by an analysis performed by the fluid chromatograph, flow rate information regarding a flow rate of a mobile phase during the analysis, and composition information regarding a composition of the mobile phase in each time period during the analysis;
a time calculation unit configured to calculate a mobile phase arrival time, which is a time required for the mobile phase delivered from a liquid sending unit of the fluid chromatograph to reach a detector, or a sample arrival time, which is a time required for a sample injected into the mobile phase to reach the detector from an autosampler of the liquid chromatograph, based on the system volume, the flow rate information, and the composition information;
an analysis range determination unit configured to determine a target range for peak analysis on the chromatogram based on the mobile phase arrival time or the sample arrival time; and
a peak analysis unit configured to execute the peak analysis within the analysis range determined by the analysis range determination unit.

2. The chromatogram analysis apparatus according to claim 1, wherein the analysis range determination unit is configured to, when a peak having a negative intensity portion appears in the chromatogram at a position near a time when the sample arrival time has elapsed from a time when the sample was injected into the mobile phase, set a time that is a predetermined time after the time when the sample arrival time has elapsed from the time when the sample was injected into the mobile phase as a start time of the analysis range.

3. The chromatogram analysis apparatus according to claim 2, wherein the analysis range determination unit is configured to, when a peak having no negative intensity portion appears in the chromatogram at a position near a time when the sample arrival time has elapsed from a time when the sample was injected into the mobile phase, set a time that is a predetermined time before the time when the sample arrival time has elapsed from the time when the sample was injected into the mobile phase as a start time of the analysis range.

4. The chromatogram analysis apparatus according to claim 1, wherein the analysis range determination unit is configured to set a time that is a predetermined time before a time when the mobile phase arrival time has elapsed from a time when the composition of the mobile phase delivered by the liquid sending unit was rapidly changed, at a time after gradient elution of the mobile phase in the chromatogram has ended, as an end time of the analysis range.

5. The chromatogram analysis apparatus according to claim 1, wherein the composition information is a preset gradient program for the mobile phase.

6. The chromatogram analysis apparatus according to claim 1, wherein the system volume includes a first system volume, which is a volume from an autosampler for injecting a sample to a detector, and a second system volume, which is a volume from a liquid sending unit for sending a mobile phase to the detector.

7. The chromatogram analysis apparatus according to claim 3, wherein the analysis range determination unit is configured to set a time that is a predetermined time before a time when the mobile phase arrival time has elapsed from a time when the liquid sending unit changed the concentration from a gradient final concentration to an equilibration concentration or a washing concentration, as an end time of the analysis range.
